(19) United States
(12) Patent Application Publication
(10) Pub. No.: US 2026/0277673 A1
(43) Pub. Date: Sep. 17, 2026

(54) PROCESSING QUEUED TASKS IN A MULTI-TENANT SYSTEM

(71) Applicant: Hewlett Packard Enterprise Development LP, Spring, TX (US)

(72) Inventors: Dhrumil Hirenkumar Desai, Fremont, CA (US); Senthil Kumar Veeraswamy Santhanam, Milpitas, CA (US); Piyush Agarwal, Sunnyvale, CA (US); Praveen Kumar Muthuswamy, Foster City, CA (US)

(21) Appl. No.: 19/018,863

(22) Filed: Jan. 13, 2025

(51) Int. Cl. G06F 9/48

(52) U.S. Cl. CPC G06F 9/4887

(57) ABSTRACT

A method may include receiving task metadata that may include an identifier of a task to be performed by a processing unit. The method may involve retrieving operational data associated with the task metadata from a database including sets of operational data corresponding to tasks for performance. The method may include attempting performance of the task based on the operational data and determining whether performance of the task is completed within a threshold amount of time. When the task is be completed within the threshold amount of time, the method may include deleting the operational data for the task from the database. When performing the task is not completed within the threshold amount of time, the method may involve discontinuing the performance of the task and discarding the task metadata and the operational data from the processing unit without removing the operational data from the database.

### BACKGROUND

Multi-tenant systems, such as cloud-computing services, may receive and process requests from a number of computing systems at various times. These requests may be queued by the multi-tenant system and processed by a number of processing units based on certain grouping parameters, ordering parameters, or the like. However, a number of issues may exist with regard to equitably and efficiently processing the queued requests received from the large number of computing systems within the same time period.

### DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example multi-tenant system, in accordance with aspects of the present disclosure;

FIG. 2 illustrates an example data flow chart of task requests being received by a multi-tenant queuing system from multiple tenant systems for processing by the multi-tenant queuing system, in accordance with aspects of the present disclosure;

FIG. 3 illustrates an example distribution of task metadata from different tenant systems within different queues for processing by the multi-tenant queuing system, in accordance with aspects of the present disclosure;

FIG. 4 illustrates an example flow chart of a method for queuing task metadata within the multi-tenant queuing system for processing, in accordance with aspects of the present disclosure; and

FIG. 5 illustrates an example flow chart of a method for processing tasks received via queues within the multi-tenant queuing system, in accordance with aspects of the present disclosure.

### DETAILED DESCRIPTION

Multi-tenant systems, such as cloud-computing systems, server-client systems, and the like, may receive requests to perform various processing tasks from a number of different tenants or client systems. The volume of tasks generated by each of the tenants may vary greatly. The variance between the number of tasks requested by any individual tenant or client may cause the multi-tenant system to serve or process tasks provided from one tenant in an unequitable manner, as compared to other tenants that may provide fewer task requests. That is, for instance, a first tenant that sends a number of task requests at one time may consume a large portion of a queue (or buffer) that receives the task requests as compared to other tenants. If the same queue receives multiple task requests from the first tenant prior to receiving a single task request from a second tenant, a processing unit of the multi-tenant system may work to process each of the tasks requested via the task requests received from the first tenant via the queue before processing any of the tasks in the queue provided by the second tenant via task requests. As a result, the second tenant may be forced to wait for the collection of tasks requested by the first tenant to be processed before its single task can be processed. As a result, the second tenant may experience inequitable delays in processing its tasks because the first tenant consumed an inequitable portion of the queue's capacity as compared to the second tenant.

Examples described herein may incorporate a database within the multi-tenant system to persistently store operational data related to performing tasks requested via task requests received by the multi-tenant system. In such examples, a processing unit assigned to process a task may retrieve the relevant operational data for processing the task from the database. For example, after receiving a task request, a task scheduler of the multi-tenant system may send operational data (including information related to processing the task requested via the task request) to the database for retrieval by a processing unit at a later time. In such examples, the task scheduler may send task metadata (e.g., tenant identifier, sequence identifier, task function) associated with the task to a queue from which one or more processing units of the multi-tenant system are able to draw the task metadata during task processing.

In some examples, a processing unit may receive the task metadata for a task from a queue and, based on the task metadata, may identify and retrieve the operational data associated with the task from the database. In some examples, processing units may not be associated with particular queues. Instead, each processing unit may employ a dynamic-consumerism technique in which each processing unit may select or receive task metadata for a task from any of a number of queues of the multi-tenant system to enable the system to more efficiently process the tasks across all of the queues.

In addition, in some instances, if a fault occurs when a processing unit is processing one task of a queue, the processing unit may stop processing subsequent tasks until the fault is resolved. As a result, processing of tasks following a task associated with a fault may be delayed until the fault is resolved (which may be an example of head-of-line blocking, for example), or the processing unit may continue to attempt to process the task indefinitely causing delays for processing subsequent tasks in the queue. Additionally, if operational data for tasks were stored in queues and distributed from there to the processing units, then the operational data for a particular task may be lost if the processing unit were to experience a fault while processing the task and as such the task may not be reattempted later.

To address these issues, examples described herein may incorporate a database within the multi-tenant system to persistently store operational data for tasks, and place task metadata for the tasks in the queues for distribution to the processing units, as described above. In such examples, when a task is successfully processed by a processing unit, the processing unit may delete the operational data for that task from the database after completing the task and then proceed to retrieve task metadata for another task from a suitable queue. When a given task is attempted by a processing unit and is determined not to be successfully completed according to a completion metric, then the processing unit may leave the operational data for the given task in the operational database, discontinue processing the given task, and move on to attempt another task. For example, in response to detecting a failure or fault in processing the given task, the processing unit may stop attempting to process the given task, may leave the operational data for the given task in the database (i.e., not remove the operational data from the database), and proceed to process a different task. In this manner, examples described herein may enable processing units to discontinue tasks that are not being completed successfully in an expected amount of time, without losing the task itself such that the task may be reattempted (by the same or another processing unit) at a later time.

In such examples, a task scanner may periodically scan the database for operational data for tasks that have been received for processing yet have remained in the database for more than some threshold amount of time. Upon detection of these uncompleted tasks, the task scanner may reschedule the processing of the task by sending the task metadata for the respective tasks to the task scheduler again for distribution to respective queues.

In this way, the processing unit may avoid delaying the processing of any tasks that are in the queue after a collection of tasks consuming a large portion of a queue, after one or more tasks that are taking more than some threshold amounts of times for processing, after another task that is experiencing a fault, or the like. For example, by continuously deleting tasks that have been successfully processed, the processing unit may ensure that the operational data related to tasks that have not been processed due to delays in the queue or faults occurring while processing a task remain in the database for rescheduling. Moreover, in some instances in which the processing unit receives the operational data via the queue, the processing unit may discontinue processing a task after detecting a fault event by discarding or deleting the operational data associated with the faulty task. By maintaining the operational data in the database until the respective task has been successfully processed, the processing unit may maintain a database of operational data for tasks that have yet to be successfully processed. Further, the task scanner may monitor the operational data for various tasks and detect when certain tasks have remained in the database for more than a threshold amount of time, such that it may reschedule the tasks for processing without losing the corresponding operational data.

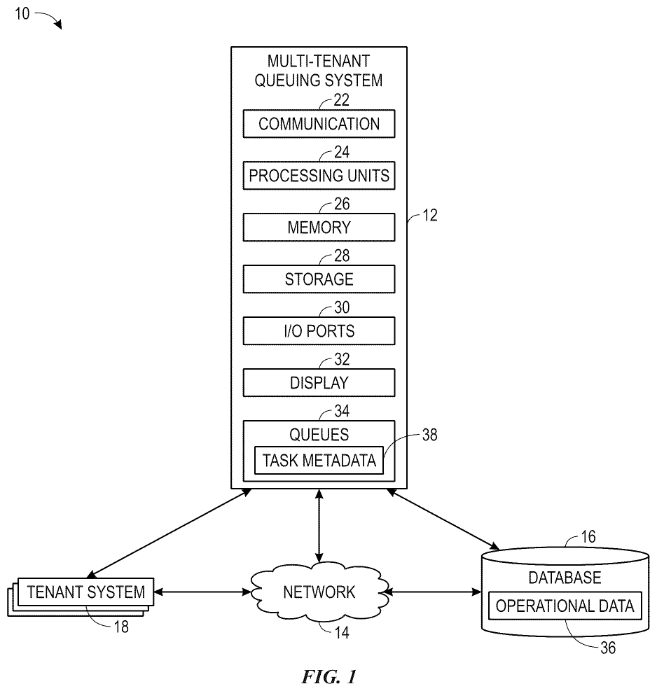

FIG. 1 illustrates an example multi-tenant system 10, in accordance with aspects of the present disclosure. The multi-tenant system 10 may be implemented via hardware (e.g., electronic circuitry) or a combination of hardware and programming (the combination comprising, e.g., at least one processor and instructions executable by the at least one processor and stored on at least one machine-readable storage medium). In the multi-tenant system 10, multiple tenants (e.g., clients, users, or other entities) may share resources, such as an instance of an application, a database, a server, or other computing resources or components, or a combination thereof. By way of example, the multi-tenant system 10 may implement a cloud-computing system that may include a network of server systems that provide computing resources (e.g., storage, processing databases) for a number of tenants. As such, the multi-tenant system 10 may provide functionalities such as software-as-a-service (SaaS) and other service model operational features.

As shown in FIG. 1, the multi-tenant system 10 may include a multi-tenant queuing system 12 that may communicate with a network 14, a database 16, one or more tenant systems 18, and the like. The network 14 may include any suitable network that facilitates communication between computing systems, electronic devices, and the like to enable the exchange of data and share resources between each other. The network 14 may include routers, switches, and other traffic directing devices to control the flow of data between senders and recipients. The network 14 may include a wired network, a wireless network, or both. By way of example, the network 14 may include a Local Area Network (LAN), a Wide Area Network (WAN), the Internet, an Intranet, and the like.

The tenant systems 18 may send requests to the multi-tenant queuing system 12 to perform certain tasks. The tasks may be related to processing tasks, such as performing one or more logical operations on data that may be defined by the respective tasks. The tenant systems 18 may leverage the shared processing capabilities of the multi-tenant queuing system 12 to efficiently process the tasks, take advantage of parallel processing by multiple processing units, and the like.

In such examples, the multi-tenant queuing system 12 may include a number of components to perform the various operations described herein. For example, the multi-tenant queuing system 12 may include a communication component 22, processing units 24, a memory 26, a storage 28, input/output (IO) ports 30, a display 32, queues 34, and the like. The communication component 22 may be a wireless or wired communication component that facilitates communication between the multi-tenant queuing system 12, the tenant systems 18, and any other suitable electronic device.

Each of the processing units 24 may include multiple processor devices that may be of any type of computer processor or microprocessor capable of executing computer-executable code. Each processing unit 24 may also include multiple processors that may perform the operations described below. The processing units 24 may perform or execute tasks provided by the tenant systems 18 (e.g., clients). That is, the tenant system 18 may include limited processing capabilities, software applications, or the like and may employ the multi-tenant queuing system 12 to supplement those limitations. Additional details with regard to the multi-tenant queuing system 12 efficiently performing or executing tasks provided by the tenant systems 18 will be discussed below.

The memory 26 and the storage 28 may be any suitable article of manufacture that may serve as media to store processor-executable code, data, or the like. These articles of manufacture may represent computer-readable media (i.e., any suitable form of memory or storage) that may store the processor-executable code used by the processing units 24 to perform the presently disclosed techniques. The memory 26 and the storage 28 may represent non-transitory computer-readable media (e.g., any suitable form of memory or storage) that may store the processor-executable code used by the processing units 24 to perform various techniques described herein. It should be noted that non-transitory merely indicates that the media is tangible and not a signal.

The IO ports 30 may provide access to the tenant systems 18, one or more input devices, one or more displays 32, or the like to facilitate human or machine interaction with the multi-tenant queuing system 12. The display 32 may operate to depict visualizations associated with software or executable code being processed by the processing units 24. In one embodiment, the display 32 may be a touch display capable of receiving inputs from a user of the multi-tenant queuing system 12. The display 32 may be any suitable type of display, such as a liquid crystal display (LCD), plasma display, or an organic light emitting diode (OLED) display, for example. Additionally, in one embodiment, the display 32 may be provided in conjunction with a touch-sensitive mechanism (e.g., a touch screen) that may function as part of a control interface for the multi-tenant queuing system 12.

The multi-tenant queuing system 12 may also include a number of queues 34 or buffers that may receive datasets from the tenant systems 18 or the like. The queues 34 may correspond to temporary memory storage components that manage the flow of data received by the multi-tenant queuing system 12. With this in mind, the tenant systems 18 may send numerous task requests to the multi-tenant queuing system 12, which may receive the task requests via the queues 34. In some cases, task requests from individual tenant systems 18 may be grouped together and sent to the same queue 34. In addition, task requests may be grouped according to some logical grouping such as order that task was received, type of task being requested, type of software application associated with requested task, and the like. For example, task requests associated with performing email operations (e.g., send email, receive email) may be grouped together and directed to the same queue 34.

Although the components of the multi-tenant queuing system 12 are depicted with respect to the multi-tenant queuing system 12, it should be noted that the tenant systems 18 or any other computing or processing device described herein may also include the same or similar components to perform, or facilitate performing, the various operations described herein. Moreover, it should be understood that the components described above are exemplary figures and the multi-tenant queuing system 12 and other suitable computing systems may include additional or fewer components as detailed above.

In some instances, the tenant systems 18 may send task requests to be processed by the multi-tenant queuing system 12. As such, the multi-tenant queuing system 12 may receive a number of task requests during any given time period and may group the received task requests according to a logical grouping, such that the task requests are sent to a queue 34 associated with the grouping. In some cases, if one of the queues 34 receives a number of tasks requests from a first tenant system 18 and one task request from a second tenant system 18, the second tenant system 18 may wait for the tasks requested by the first tenant system 18 to be processed even if the requests were sent within milliseconds of each other. In addition, if one of the collection of task requests sent from the first tenant system 18 is associated with a fault, the respective processing unit 24 may not be able to process the task request from the second tenant system 18 until the fault is resolved.

To more efficiently and equitably process tasks received from various tenant systems 18, the multi-tenant queuing system 12 may send operational data 36 related to the task requests to the database 16. The database 16 may include any suitable storage component, such as non-volatile storage medium. In this way, the database 16 may store specific task information related to the requested tasks to be performed. The operational data 36 may include one or more indications of actions to be performed on datasets by a respective processing unit 24. In some examples, the one or more indications of actions may include logic, instructions, functions, algorithms, or the like, or a combination thereof.

In addition to sending the operational data 36 to the database 16, the muti-tenant queuing system 12 may send task metadata 38 to the queue 34. The task metadata 38 may include information related to the requested task. For instance, the task metadata may include an identifier of the tenant system 18 that sent the task request, an identifier of the corresponding operational data 36, a sequence identifier indicative of a place in a sequence of tasks for the respective task, a function associated with the task, a type of task, and other suitable information that may assist the processing unit 24 to identify the corresponding operational data (e.g., task data) stored in the database 16. After receiving the task metadata 38, the processing unit 24 may use the information stored therein to retrieve the operational data 36 to process the task.

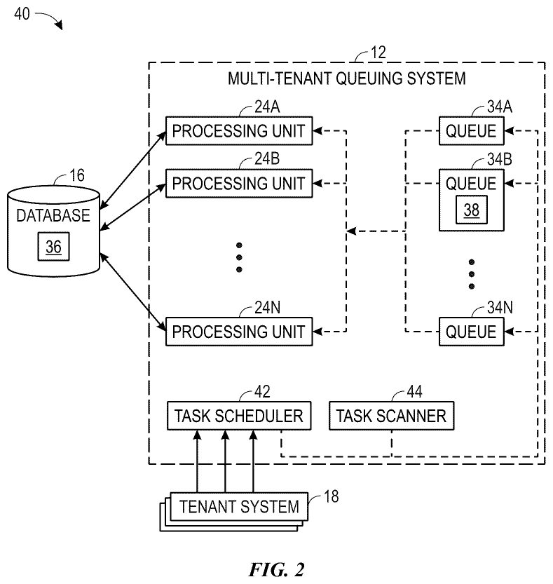

In addition to the database 16, the multi-tenant queuing system 12 may employ a task scheduler 42 and a task scanner 44 to schedule the processing of tasks requested by the tenant systems 18 in accordance with techniques described herein. For example, FIG. 2 illustrates an example data flow chart 40 of task requests being received by the task scheduler 42 of the multi-tenant queuing system 12 from tenant systems 18. The task scheduler 42 may be implemented via hardware (e.g., electronic circuitry) or a combination of hardware and programming (the combination comprising, e.g., at least one processor and instructions executable by the at least one processor and stored on at least one machine-readable storage medium) of the multi-tenant queuing system 12. For example, the task scheduler 42 may be executed by one of the processing units 24 or a separate processing system. The task scheduler 42 may receive the task requests from the tenant systems 18 and extract operational data (e.g., operational data 36) and metadata (e.g., task metadata 38) from the task request. The task scheduler 42 may send the operational data 36 to the database 16 for storage and the task metadata 38 to one of the queues 34 for distribution to one of the processing units 24.

By way of example, the task scheduler 42 may receive a task request from the tenant system 18. The task scheduler 42 may then identify one of the queues 34 to send the task metadata 38 of the task request, such that one of the processing units 24 may process the requested task. As discussed above, the task scheduler 42 may identify one of the queues 34 to send the task metadata 38 based on a logical grouping associated with each queue 24. For instance, each queue 24 may be associated with different groups of tasks, such as a task type, a task priority, or any other suitable grouping algorithm. After identifying the queues 34 that is associated with the received task request, the task scheduler 42 may send the task metadata 38 for the task request to the identified queue 34.

After the task metadata 38 is sent to the queue 34, the processing unit 24 may receive the task metadata via the queue 34 and identify the corresponding operational data 36 stored in the database 16 based on the information provided by the task metadata 38. The processing unit 24 may, in turn, retrieve the corresponding operational data 36 and process it to perform the respective task. In this way, the queue 34 may store the task metadata 38 without the operational data 38 to enable the processing unit 24 to more flexibly retrieve and process the respective task in accordance with techniques described herein.

In some implementations, each processing unit 24 may receive task metadata 38 from any of the queues 34 as the processing unit 24 becomes available for processing. That is, each processing unit 24 may not be tied to or associated with any one particular queue 34 and may select to receive the task metadata 38 from any of the queues 34. In this way, the processing units 24 may efficiently process tasks from the collection of queues 34 to improve processing efficiency, as compared to using one processing unit 24 for any one queue 34. Indeed, each processing unit 24 may selectively process tasks from any queue 34 based on its respective availability, as opposed to the data stored in any particular queue 34.

After processing a respective task using the respective operational data 36, the processing unit 24 may delete or remove the operational data 36 from the database 16. In this way, the database 16 may include the operational data 36 for tasks that are in queue or that have not been completely processed. In some instances, the processing unit 24 may attempt to process a task by retrieving the operational data 36 but the processing of the respective task may become corrupted or associated with some fault (e.g., timeout). For example, if the processing unit 24 does not complete processing the task within a threshold amount of time, the processing unit 24 may discontinue processing the respective task and proceed to process another task available via any of the queues 34. However, unlike when the processing of a task is successfully completed, when the processing unit 24 discontinues processing the task before completion, the processing unit 24 may refrain from deleting the respective operational data from the database 16.

As the multi-tenant queue system 12 processes various tasks, the task scanner 44 may periodically (e.g., milliseconds, minutes) or upon request scan the database 16 to identify operational data for tasks that have remained in the database 16 for more than a threshold amount of time. The operational data 36 that remain in the database 16 for more than the threshold amount of time may indicate that corresponding tasks are positioned in a queue 34 behind a series of time-intensive tasks. In addition, the remaining operational data 36 may also correspond to tasks that are associated with a fault and may thus remain uncompleted tasks until after being rescheduled. The task scanner 44 may be implemented via hardware (e.g., electronic circuitry) or a combination of hardware and programming (the combination comprising, e.g., at least one processor and instructions executable by the at least one processor and stored on at least one machine-readable storage medium) within the multi-tenant queuing system 12 to assist in efficiently processing the tasks received from the tenant systems 18. In some implementations, the task scanner 44 may be implemented by one of the processing units 24, a separate processing system, or the like.

The task scanner 44 may query the database 16 and track the tasks stored therein over the threshold amount of time. If the task scanner 44 determines that any operational data for a task has been stored in the database 16 for more than the threshold amount of time, the task scanner 44 may send or coordinate with the task scheduler 42 to send corresponding task metadata 38 for the identified task to one of the queues 34 based on the associated grouping. The task metadata 38 may be generated by the task scanner 44 based on the corresponding operational data 36 identified in the database 16. The processing unit 24 that receives the respective task metadata 38 may again retrieve the operational data 36 from the database 16 and attempt to process the task. As a result, any fault that occurs while processing a task may not indefinitely delay the processing of a subsequent or other task by the respective processing unit 24. Further, by receiving just the task metadata 38 while preserving the operational data 38 in the database 16, the processing unit 24 may safely discontinue processing any particular task without losing the operational data 36 to perform that task at a later time. As a result, the processing unit 24 may provide improved efficiency in the use of its processing capabilities by limiting the amount of time and computing resources afforded to a task that may be associated with a fault, while continuing the processing of tasks received by the queue 34 after the faulty task.

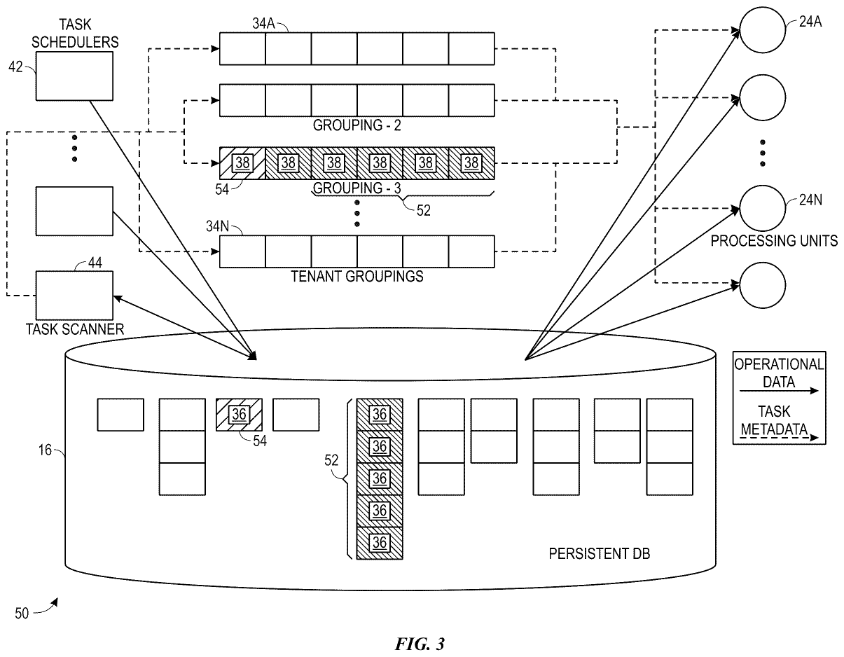

To better illustrate the operations of the current techniques described herein, FIG. 3 illustrates an example distribution 50 of task requests from different tenant systems 18 within different queues for processing by the multi-tenant queue system 12, in accordance with aspects of the present disclosure. As shown in FIG. 3, a set of tasks 52 may be stored in the database 16 by the task scheduler(s) 42. In some implementations, the set of tasks 52 may include a number of individual tasks that are to be performed in a sequential order, a number of individual tasks may be received from a single tenant system 18, or the like. In any case, the task scheduler 42 may send task metadata 38 associated with the set of tasks 52 to queue 34C for processing by one of the processing units 24. After one of the processing units 24 become available, the one processing unit 24 may begin processing a first task of the set of tasks 52 by retrieving the operational data 36 for the first task from the database 16.

The task scanner 44 may monitor the status of the tasks stored in the database 16 over a period of time. If any of the tasks remain in stored in the database 16 for more than a threshold amount of time, the task scanner 44 may send an indication to the task scheduler 42 to resend the task metadata 38 for the identified task to one of the queues 34. Referring to FIG. 3, task 54 may be positioned after the set of tasks 52. As such, if the set of tasks 52 take more than the threshold amount of time to be processed by one of the processing units 24 due to sequential nature of the set of tasks 52, due to the processing time associated with the set of tasks 52, due to a fault occurring when processing one task of the set of tasks 52, or the like, the task scanner 44 may identify the task 54 remaining in the database 16 and redeploy task metadata 38 associated with the task 54 to a different queue 34 to enable a different processor 24 to process the task 54.

In addition, since each of the processing units 24 may access each of the queues 34, any processing unit 24 may receive task metadata 38 from any queue 34 for processing. Moreover, if any one of the processing units 24 encounters a fault while processing one task of the set of tasks 52, for example, the respective processing unit 24 may discontinue processing the respective task and begin processing a subsequent task. Since task metadata 38 is provided in the queue 34, the processing unit 24 can delete the task metadata 38 associated with the fault and retrieve operational data 36 for a subsequent task from the database 16 based on subsequently received task metadata 38. By storing the operational data 36 in the database 16, as opposed to sending it in the queue 34, any faults or timeouts experienced by the respective processing unit 24 do not tie up or render the respective queue 34 inoperable for an indefinite amount of time. Instead, by preserving the operational data 36 in the database 16, the task scanner 44 may become aware of the fault or the incomplete task, such that it may be redeployed.

In some implementations, the task scanner 44 may track a number of times any individual task may be redeployed and maintain statistics related to processing the respective task. Based on the recorded data, the task scanner 44 may identify tasks that may be associated with a fault, tasks that may not be compatible for processing by the processing units 24, or the like and provide an indication to the respective tenant system 18 that provided the task.

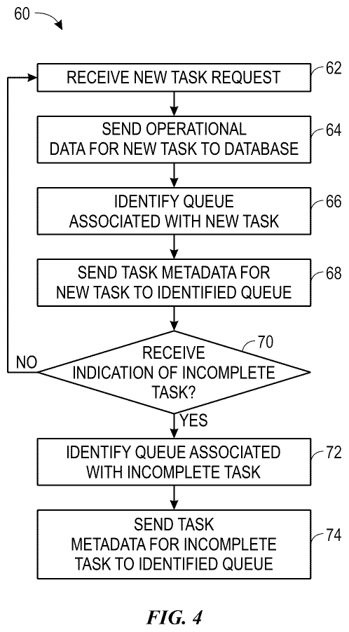

FIG. 4 illustrates an example flow chart of a method 60 for sending task requests to the multi-tenant queue system for processing, in accordance with aspects of the present disclosure. Although the following description of the method 60 will be discussed as being performed by the task scheduler 42 in a particular order, it should be noted that the method 60 may be performed by any suitable computing component in any suitable order.

Referring now to FIG. 4, at block 62, the task scheduler 42 may receive a new task request from one of the tenant systems 18. The task request may be a request to perform a task comprising at least one processing operation using one or more of the processing units 24. The processing operations may include any suitable analysis or algorithmic operation, such as sending messages across the network 14, performing calculations, rendering visualizations, applying logic functions, and the like. The task request may include operational data 36 related to the requested processing operations (e.g., task) to be performed. In addition, each task request may include task metadata 38 that may identify the respective task request, the corresponding operational data 36, and the like. In some implementations, the task metadata 38 may include information such as an identifier of the task, an identifier associated with the operational data 36, a sequence identifier associated with the respective task with respect to other related tasks, and any suitable type of information that may identify the task. In addition, as discussed above, he operational data 36 may include one or more indications of actions, which may include logic, instructions, functions, algorithms, or the like, to be performed on datasets by a respective processing unit 24.

After receiving the task request, the task scheduler 42 may, at block 64, send the operational data 36 to the database 16 for storage. The database 16 may be a persistent database that may store the operational data for a period of time. In some implementations, the operational data 36 may be stored in the database 16 until after the respective task is processed.

At block 66, the task scheduler 42 may identify a queue 34 to send the corresponding task metadata 38. The task scheduler 42 may select one of the queues 34 to send the task metadata 38 based on any suitable scheduling strategy. For example, the task scheduler 42 may identify the queue 34 based on a current available capacity of a respective queue 34. In addition, the task scheduler 42 may determine whether a set of interrelated tasks are present on any queue 34 and avoid sending another task to that queue 34 to help the respective task be processed in a more equitable manner. In yet another implementation, the task scheduler 42 may send the task to a particular queue 34 based on a logical grouping associated with a respective queue 34. For instance, each queue 34 may be associated with different types of tasks, different types of software applications, different types of processing requests, and the like. As such, the task scheduler 42 may identify the queue 34 that corresponds to the received request to send the respective task metadata 38.

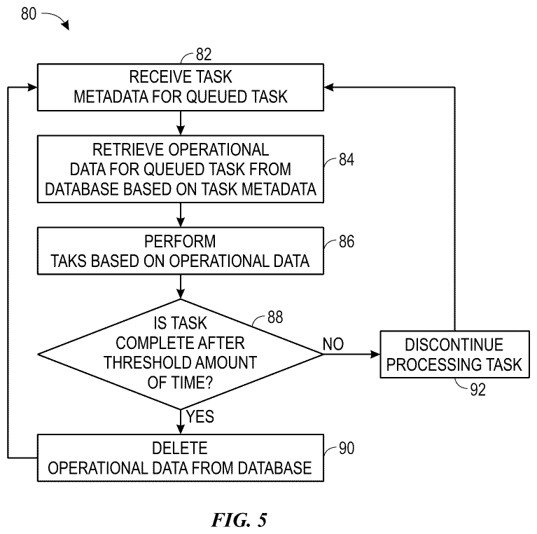

After identifying the queue 34, at block 68, the task scheduler 42 may send the task metadata 38 to the identified queue 34. As discussed above, the task metadata 38 may include information that may be useful in identifying the respective task, the corresponding operational data stored in the database 16, and the like. By sending just the task metadata 38 to the queue 34 instead of the task metadata 38 with the corresponding operational data 36 to the queue 34, the queues 34 may be used in a more efficient manner, such that each queue 34 may accommodate more tasks. As will be discussed in more detail below with reference to FIG. 5, one of the processing units 24 may then receive the task metadata 38 and perform the requested processing operation by retrieving the operational data 36 associated with the task metadata 38 from the database 16.

In some implementations, the task scheduler 42 may, at block 70, determine whether it received an indication of a presence of an incomplete task or a task that has not been processed by any of the processing units 24 after a threshold amount of time of being stored in the database 16. That is, the task scanner 44 may periodically scan the database 16 to identify any operational data 36 that has remained in the database 16 for more than the threshold amount of time. The threshold amount of time may correspond to an expected time period for the respective task metadata 38 to be sent to the queue 34 and a respective processing unit 24 to process the respective task. The threshold amount of time may also include some margin to account for any reasonable delay. In any case, if the task scanner 44 determines that one of the tasks associated with operational data 36 stored in the database 16 has not been processed, the task scanner 44 may send the indication of the unprocessed task to the task scheduler 42. The indication may include an identifier of the respective task, the respective task metadata 38, or any other suitable information to enable the task scheduler 42 to reschedule the task for processing.

In response to receiving the indication, the task scheduler 42 may proceed to block 72 and identify a suitable queue 34 to send the task metadata 38 for the incomplete task, as described above with respect to block 66. The task scheduler 42 may then, at block 74, send the task metadata 38 for the incomplete task to the identified queue 34 at block 74.

Returning to block 70, if the task scheduler 42 does not receive the indication of the incomplete task, the task scheduler 42 may return to block 62 and continue to perform the method 60. In this way, the task scheduler 42 may continuously schedule requested tasks and tasks that have been identified as incomplete or unprocessed to ensure that all of the received task requests are processed.

As mentioned above, after the task metadata 38 is sent to a respective queue 34, a processing unit 24 may receive the task metadata 38 and perform any respective processing operations related to the respective task based on the corresponding operational data stored in the database 16. For example, FIG. 5 illustrates an example flow chart of a method 80 that the processing unit 24 may employ for processing tasks received via queues 34, in accordance with aspects of the present disclosure. Although the following description of the method 80 is described as being performed by one of the processing units 24 in a particular order, it should be noted that any suitable processing system may perform the method 80 in any suitable order.

Referring now to FIG. 5, at block 82, the processing unit 24 (e.g., processing unit 24A) may receive the task metadata for a task from one of the queues 34. Each processing unit 24 may have access to each queue 34, thereby enabling each processing unit 34 to maximize its processing throughput by receiving task metadata from any queue 34 instead of a subset of the queues 34. That is, the processing unit 24 may select from any of the queues 34 to begin processing operations. In some implementations, the processing unit 34 may scan each queue 34 to identify the task metadata 38 that may have the earliest timestamp associated with a time in which it was placed in one of the queues 34.

As discussed above, the task metadata 38 may include task identifier information for the task that may correspond to operational data 36 for the task that may be stored in the database 16. As such, the processing unit 24 may parse the task metadata 38 to identify the corresponding operational data 36 stored in the database 16.

At block 84, the processing unit 24 may retrieve the operational data 36 from the database 16 based on the information provided by the task metadata 38. The operational data 36 may include task specific information that may outline the processing operations requested to be performed by the processing unit 24. At block 86, the processing unit 24 may attempt to perform the requested task by executing logic, instructions or the like, and/or using specialized circuitry (e.g., parallel processing, cloud computing, machine-learning), or the like, or a combination thereof.

After the processing unit 24 begins processing the respective task, the processing unit 24 may determine (block 88) whether the task is completed successfully according to a suitable completion metric. For example, the completion metric may be based on a processing threshold amount of time, and determination of whether performance of the task is completed successfully according to the completion metric may comprise determining whether the task is completed successfully prior to receipt of a timeout signal based on the processing threshold amount of time. In some examples, the processing unit 24 may track an amount of time undertaken by the processing unit 24 to complete the processing or performing the task. The processing threshold amount of time may correspond to an expected duration of time to perform any task. As such, the threshold amount of time may be pre-defined or determined dynamically based on the type of task being performed and an expected duration of time for performing that type of task based on a history of performing similar types of tasks.

If the processing unit 24 completes the processing within the processing threshold amount of time or successfully performs the task, the processing unit 24 may proceed to block 90 and delete the corresponding operational data 36 from the database 16. In this way, the database 16 may maintain a collection of task data related to scheduled but incomplete tasks. After deleting the respective operational data 36, the processing unit 24 may return to block 82 and perform the method 80 to continuously process tasks received via any of the queues 34.

Referring back to block 88, if the processing unit 24 determines that the task has not been completed within the threshold amount of time, the processing unit 24 may proceed to block 92 and discontinue processing the task by discarding the task metadata 38 and the operational data 36 retrieved for performing the task. The processing unit 24 may then return to block 82 to process another task. In this way, the processing unit 24 may proceed to another task stored in one of the queues 34, thereby preventing other scheduled tasks from experiencing delays due to one other task that may be associated with a fault or error. Moreover, the processing unit 24 may refrain from deleting the operational data 36 from the database 16 after determining that the task has not been completed within the threshold amount of time. In this way, the processing unit 24 may preserve the operational data 36 within the database 16 for later identification by the task scanner 44 as described above.

In addition to determining whether the task is processed within the threshold amount of time, the processing unit 24 may determine whether the respective task is associated with a fault based on an error encountered during the processing, the lack of operational data 36 stored in the database 16, and the like. In response to detecting a fault associated with a respective task being processed, the processing unit 24 may proceed to block 92 and discontinue processing the task to prevent other tasks from being processed in an inefficient or inequitable manner.

As noted above, at block 88, the processing unit 24 may determine whether performance of the task is completed successfully according to a completion metric. The completion metric may be related to processing a task within a threshold amount of time as mentioned above. In some examples, determination whether performance of the task is completed successfully according to the completion metric may include determining whether the task has been performed successfully before receiving a timeout signal, without detecting a fault, or the like, or a combination thereof. If the processing unit 24 does not determine that the performance of the task is successfully completed according to the completion metric, the processing unit 24 may proceed to block 92.

As may be appreciated, the current techniques provide significant value. In particular, by sending just the task metadata 38 to the queue 34 instead of the operational data 36 and the task metadata 38, the processing unit 24 may be able to discontinue processing tasks received via the queue 34 without losing information related to performing the requested task. Moreover, by maintaining the operational data 36 in the database 16 until a respective processing unit 24 performs the respective task, incomplete or unprocessed tasks may be regularly identified and rescheduled to ensure that each received task is processed. Moreover, since each processing unit is not tied to any one queue 34, each processing unit 24 may be used to process a collection of tasks stored in all of the queues 34 in an efficient manner. Indeed, the task scheduler 42 may schedule tasks based on the current capacity of any queue 34 to ensure that any queue 34 that has a high volume of interrelated tasks are avoided, thereby reducing the unequitable processing of certain tasks received after a set of interconnected tasks.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A tangible, non-transitory, computer-readable medium, comprising computer-readable instructions that, when executed by a processing unit, cause the processing unit to:
receive, from a first queue of a plurality of queues, task metadata comprising an identifier of a task to be processed by the processing unit, wherein the processing unit is one of a plurality of processing units to process a plurality of tasks identified in the plurality of queues;
retrieve, from a database, operational data associated with the task metadata and useable by the processing unit to perform the task corresponding to the task metadata, the database to store respective sets of operational data for the plurality of tasks identified in the plurality of queues;
attempt to perform the task based on the operational data;
determine whether performance of the task is completed successfully according to a completion metric;
when performing the task is determined to be completed successfully, delete the operational data for the task from the database; and
when performing the task is determined not to be completed successfully, discontinue the performance of the task and discard the task metadata and the operational data from the processing unit without removing the operational data from the database.

2. The tangible, non-transitory, computer-readable medium of claim 1, wherein each of the plurality of processing units is configured to selectively process any of the one or more tasks.

3. The tangible, non-transitory, computer-readable medium of claim 1, wherein the computer-readable instructions cause the processing unit to:
determine that the attempt to perform the task by the processing unit is associated with a fault; and
when the attempt to perform the task is determined to be associated with the fault:
discontinue the performance of the task and discard the task metadata and the operational data from the processing unit without removing the operational data from the database; and
receive additional task metadata associated with an additional task.

4. The tangible, non-transitory, computer-readable medium of claim 1, wherein the computer-readable instructions cause the processing unit to:
scan the database to detect that the operational data is stored in the database for more than a threshold amount of time;
when the operational data is detected to be stored in the database for more than the threshold amount of time, identify a second queue of the plurality of queues based on the operational data; and
send the task metadata associated with the operational data to the second queue to enable processing of the corresponding task by any of the plurality of processing units.

5. The tangible, non-transitory, computer-readable medium of claim 4, wherein the computer-readable instructions cause the processing unit to identify the second queue based on one or more groupings of one or more tasks within each of the plurality of queues.

6. The tangible, non-transitory, computer-readable medium of claim 4, wherein the computer-readable instructions cause the processing unit to scan the database periodically.

7. The tangible, non-transitory, computer-readable medium of claim 1, wherein:
the completion metric comprises a threshold amount of time; and
the determination of whether performance of the task is completed successfully according to the completion metric comprises determining whether the task is completed successfully prior to receipt of a timeout signal based on the threshold amount of time.

8. The tangible, non-transitory, computer-readable medium of claim 1, wherein the operational data comprises one or more indications of logic to be performed by the processing unit to perform the task.

9. A system, comprising:
a plurality of processing units;
a database configured to store one or more sets of operational data associated with performing one or more tasks by any of the plurality of processing units;
a processing unit of the plurality of processing units, wherein the processing unit executes a set of computer-readable instructions that cause the processing unit to:
receive task metadata comprising an identifier of a task of the one or more tasks to be processed by the processing unit;
retrieve, from the database, operational data of the one or more sets of operational data based on the task metadata, wherein the operational data is usable by the processing unit to perform the task corresponding to the task metadata;
attempt to perform the task based on the operational data;
determine whether performance of the task is completed successfully according to a completion metric;
when performing the task is determined to be completed successfully, delete the operational data for the task from the database; and
when performing the task is determined not to be completed successfully, discontinue the performance of the task and discard the task metadata and operational data from the processing unit without removing the operational data from the database.

10. The system of claim 9, comprising:
a scanner configured to execute a second set of computer-readable instructions that cause the scanner to:
scan the database to detect additional operational data of the one or more sets of operational data that is stored in the database for more than a threshold of time, wherein the additional operational data corresponds to an additional task; and
when the additional operational data is detected to be stored in the database for more than the threshold amount of time, send a request to reschedule the performance of the additional task by any of the plurality of processing units.

11. The system of claim 10, comprising a scheduler configured to execute a third set of computer-readable instructions that cause the scheduler to:
receive the request to reschedule the performance of the additional task from the scanner;
identify a queue of a plurality of queues based on the additional operational data; and
send additional task metadata comprising an additional identifier corresponding to the additional operational data to the queue for processing by any of the plurality of processing units.

12. The system of claim 11, wherein the third set of computer-readable instructions cause the scheduler to identify the queue of the plurality of queue based on a logical grouping between one or more additional tasks associated with the one of the plurality of queues and the additional task.

13. The system of claim 12, wherein the logical grouping is associated with a type of task.

14. The system of claim 9, wherein the set of computer-readable instructions cause the processing unit to:
determine that the attempt to perform the task is associated with a fault;
when the attempt to perform the task is determined to be associated with the fault, discontinue the performance of the task and discard the task metadata and operational data from the processing unit without removing the operational data from the database; and
receive additional task metadata to attempt to perform an additional task.

15. The system of claim 13, wherein the set of computer-readable instructions cause the processing unit to:
retrieve an additional operational data from the database based on the additional metadata; and
perform one or more logical operations based on the additional operational data.

16. A method, comprising:
receiving, via a processing unit of a plurality of processing units, task metadata comprising an identifier of a task to be performed by the processing unit;
retrieving, via the processing unit, operational data associated with the task metadata from a database comprising one or more sets of operational data corresponding to one or more tasks for performance by at least one of a plurality processing units comprising the processing unit;
attempting, via the processing unit, performance of the task based on the operational data;
determining, via the processing unit, whether performance of the task is completed within a threshold amount of time;
when performing the task is determined to be completed within the threshold amount of time, delete the operational data for the task from the database; and
when performing the task is determined not to be completed within the threshold amount of time, discontinue the performance of the task and discard the task metadata and the operational data from the processing unit without removing the operational data from the database.

17. The method of claim 16, comprising:
determining, via the processing unit, that the performance of the task is associated with a fault; and
when the performance of the task is determined to be associated with the fault, discontinue, via the processing unit, the performance of the task and discard the task metadata and the operational data from the processing unit without removing the operational data from the database.

18. The method of claim 16, wherein the task metadata is received via one of a plurality of queues, and wherein each of the plurality of queues is accessible to each of the plurality of processing units.

19. The method of claim 18, wherein each of the plurality of queues is associated with a grouping of a plurality of tasks.

20. The method of claim 16, comprising:
scanning, via the processing unit, the database to detect additional operational data of the one or more sets of operational data that is stored on the database for more than an additional threshold amount of time;
when the additional operational data is detected to be stored on the database for more than the additional threshold amount of time, send additional task metadata associated with the additional operational data to an additional queue of the plurality of queues for performance of an additional task by one of the plurality of processing units.
